(19) United States
(12) Patent Application Publication
(10) Pub. No.: US 2004/0039776 A1
(43) Pub. Date: Feb. 26, 2004

(54) System and method for efficient data refresh

(76) Inventor: Eugene Ballard, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/227,684

(22) Filed: Aug. 26, 2002

(51) Int. Cl. G06F 15/16

(52) U.S. Cl. 709/203

(57) ABSTRACT

Disclosed are systems and methods for updating data at a node in a network system comprising providing a refresh status indicator at the node, wherein the refresh status indicator indicates a changed status with respect to data stored at the node and corresponding data stored at a server of the network system, periodically querying the server with respect to the refresh status indicator, updating the refresh status indicator to reflect a changed status with respect to the data stored at the node and the corresponding data stored at the server, periodically polling the status indicator to determine a status indicated thereby, and if said status indicated by the status indicator during the polling reflects a changed status with respect to the data stored at the node and the corresponding data stored at the server, querying the server with respect to the corresponding data stored at the server.

### FIELD OF THE INVENTION

The invention relates generally to client-server communications and, more particularly, to refreshing or updating information with respect to a client.

### BACKGROUND OF THE INVENTION

It is common to provide data communication between one or more clients and a server in a client-server computing system environment. For example, Internet browser clients are often placed in communication with Internet servers for access to a database of the server. Often the information retrieved from such a database is static or relatively static, e.g., changed or updated infrequently. Therefore a typical client query to retrieve appropriate information and display the retrieved information to a user through the client browser interface is performed once and the data retrieved is displayed until a subsequent query is made.

More recently the data retrieved in such client-server environments has been more dynamic in nature. For example, it has become common to use a client-server environment to facilitate quasi real-time communications between individuals. The aforementioned Internet browser clients may be utilized by each such individual to provide a frame displaying the text of messages transmitted by an associated individual and a frame displaying the text of messages transmitted by other individuals involved in the client-server hosted conversation. Such conversations are often referred to as “web chats” or “chat sessions” and may be invoked for entertainment, for seeking advice, or for other purposes.

An example of how a web chat might work is that an individual who wishes to invoke a chat session may use an Internet browser operable upon the individual's computer to access an Internet server website where chat is available. The individual may select particular content available from the server, e.g., a “web page”, which presents the option of establishing a chat session at the individual's browser. When the individual manipulates the browser to select the option for establishing a chat session, a message may be sent by the browser to the server that an individual wishes to invoke a chat session. For example, the individual may be required to make a selection, such as selecting a radio button corresponding to a chat session desired displayed on the browser, and implement a send data function, such as by mouse clicking a “proceed” or “send” button displayed on the browser.

It should be appreciated that in the client-server environment, particularly in the aforementioned Internet scenario, the server is responsive to the client's queries and, therefore, the client generally must take action to provoke desired server activity. Accordingly, the server will await the individual's response regarding the chat session and, when received, will update a register or database showing that the individual is desirous of establishing the indicated chat session. In the example, it is assumed that the individual has indicated a desire to communicate with a service agent regarding a technical or equipment service issue. Therefore, a database at the server regarding individuals desirous of chatting with service agents is updated with the individual's information. It should be appreciated that the aforementioned agent may be any of a number of persons to which the aforementioned individual may desire to be placed in communication. For example, an agent may staff a help desk employed to assist individuals with technical questions and/or to resolve problems. Additionally or alternatively, an agent may provide sales advice or any other information desired by an individual.

The server may provide a chat session web page to the individual's browser in anticipation of the chat session being invoked. The chat session web page may include a frame (e.g., individual's send frame) for displaying messages to be typed by the individual and communicated to another party to the conversation, as well as a frame (e.g., individual's receive frame) for displaying messages typed by another party to the conversation after having been received by the browser via the server. These frames will typically be blank or contain default text, perhaps providing instructions with respect to participating in the chat session, when the chat session web page is initially delivered to the browser by the server. However, the server will generally include a database or databases for storing messages associated with these frames (message database).

Although the individual may be able to type messages into the individual's send frame, the server will not be updated until the individual manipulates the browser to update the server, such as to mouse click a “send” button displayed on the browser. After input of a message and manipulation of the browser to update the server, the message may be stored in the aforementioned message database of the server. Ancillary information, such as the sender of the message and/or the intended recipient of the message, may also be stored by the server.

Similar to the aforementioned individual, an agent or agents may utilize an Internet browser operable at the agent's computer to access the aforementioned Internet server website where chat is available. The server may provide a chat session web page to the agent's browser in anticipation of the chat session being invoked. As with the individual discussed above, the chat session web page may include a frame (e.g., agent's send frame) for displaying messages to be typed by the agent and communicated to another party to the conversation, as well as a frame (e.g., agent's receive frame) for displaying messages typed by another party to the conversation after having been received by the browser via the server.

The agent's chat session web page may be configured somewhat differently than the aforementioned individual's chat session web page, such as to provide control or management functions to the agent. For example, the chat session web page provided to the agent's browser may further include a frame (e.g., conversation select frame) to allow an agent to select an individual with which to conduct a conversation. Information regarding individuals desirous of chatting with service agents may be accessed by the server to provide a list of individuals in the conversation select frame when the chat session web page is server up to the agent's browser by the server. The agent may select a particular individual with which to conduct a conversation and manipulate the browser to send the selection to the server, such as by mouse clicking a “proceed” or “send” button displayed on the browser. The server may then update the database of individuals desirous of chatting with service agents to show the selected individual as having been selected by an agent.

It should be appreciated that, although the selected individual may have composed a message and caused the individual's browser to update the message database of the server to include the message, the agent's receive frame will not yet display this message. This is because the agent's browser must query the message data from the server. Such queries may be invoked independently or upon the occurrence of another function. For example, the agent's manipulation of the browser to update the selection of an individual for a chat session may further invoke a refresh of the agent's receive frame to retrieve any messages already sent by the selected individual. Accordingly, the server may search the message database for messages from the selected individual, compile a query response including each such message, and provide the agent's browser with the query response for displaying within the agent's receive frame. Updating of the agent's browser to display the query response typically involves blanking the agent's receive frame and refreshing the agent's receive frame with the query response, resulting in a visible “blinking” or “flashing” of the frame.

The chat session may proceed with the agent typing a message, manipulating the agent's browser to send the message to the server, and the server storing the message in the message database. However, the individual's browser will not display the agent's message until such time as the individual's browser queries the server to refresh the individual's receive frame. As discussed above, such a refresh may occur with operation of another function or independently. Accordingly, if the individual does not perform any function which triggers the aforementioned refresh of the individual's receive frame the refresh query must be purposefully invoked or the individual will not be presented with the agent's message. A similar result can be expected with respect to the agent receiving the individual's messages during the chat session.

To avoid the parties to a conversation having to constantly manually select a refresh query, automatic code has been implemented within the clients to periodically implement a refresh query. For example, the individual's and agent's browsers may operate under control of an instruction set, typically client side JAVA script may be used to query the server every 30 seconds. Accordingly, every 30 seconds the individual's browser will query the server, the server will search the message database for all messages from the appropriate agent, and provide a query response including each such message for refreshing the individual's receive frame. Similarly, every 30 seconds the agent's browser will query the server, the server will search the message database for all messages from the selected individual, and provide a query response including each such message for refreshing the agent's receive frame.

The intervals at which such refresh queries are made are typically selected so as to provide refreshing of message frames with an acceptable amount of latency in the quasi real-time conversation. For example, a worst case scenario would result in one party to a conversation updating the message database at the server immediately after the other party to the conversation's browser performed a refresh query. In the above example of the refresh periodicity being 30 seconds, the other party's browser would not be refreshed with this message for approximately another 30 seconds, thereby resulting in a 30 second latency in the communication of the message. The sluggishness of this latency as viewed by the party originally sending the message could be compounded by a similar situation occurring with respect a reply from the other party. The latency may be decreased by reducing the refresh periodicity, such as from 30 seconds to 10 seconds, but at the expense of requiring more processing by the server.

It should be appreciated that each time a refresh query is made by a client, the server requires an appreciable amount of processing to parse the message database, form a query response, and transmit the response to the appropriate client. These queries will often provide no new message information to the querying client, because the periodicity of the automatic queries is typically selected to be short enough to provide an acceptable amount of latency in the conversation as discussed above. Accordingly, a large amount of the processing of such queries by the server provides no new information to the client and the technique unnecessarily consumes a large amount of sever processing power. Moreover, a large amount of communication bandwidth is consumed transmitting the query responses, including all messages matching the query whether unchanged or not, to the clients. These disadvantages are further compounded by the fact that the client-server environment typically includes a plurality of chat sessions being conducted simultaneously and/or a relatively large number of clients conducting conversations via the server.

A further disadvantage of such a technique for refreshing the data displayed at the browser is that each time the query result is received from the server, the browser refreshes the associated frame. This causes the aforementioned blinking of the frame with the same periodicity as the automatic refreshes. As mentioned above, the refresh queries can be quite frequent in order to reduce latency. Therefore, the blinking of the frame can be frequent and quite distracting.

### BRIEF SUMMARY OF THE INVENTION

Embodiments of the present invention provide systems and methods for updating data at a node in a network system comprising providing a refresh status indicator at the node, wherein the refresh status indicator indicates a changed status with respect to data stored at the node and corresponding data stored at a server of the network system, periodically querying the server with respect to the refresh status indicator, updating the refresh status indicator to reflect a changed status with respect to the data stored at the node and the corresponding data stored at the server, periodically polling the status indicator to determine a status indicated thereby, and if said status indicated by the status indicator during the polling reflects a changed status with respect to the data stored at the node and the corresponding data stored at the server, querying the server with respect to the corresponding data stored at the server.

### BRIEF DESCRIPTION OF THE DRAWINGS

FIG. 1 shows a network system in which an embodiment of the present invention is deployed;

FIG. 2 shows a computer adapted to implement aspects of the present invention;

FIG. 3 shows client and server interaction according to an embodiment of the present invention;

FIG. 4 shows a flow diagram of refreshing of a refresh frame according to an embodiment of the present invention; and

FIG. 5 shows a flow diagram of refreshing a data frame referencing a refresh variable according to an embodiment of the present invention.

### DETAILED DESCRIPTION

The present invention is directed to systems and methods which refresh or update data at a client in a client-server environment using a status query to indicate whether particular data requires refreshing or updating. According to an embodiment of the invention, a refresh frame is utilized by an Internet browser to query a server periodically as to whether information associated with another frame or frames of the browser should be refreshed. By using a refresh frame of the present invention, unnecessary refreshing of other frames displayed by the browser, such as a chat session receive frame, is avoided. Specifically, a refresh frame of the present invention may be configured to query a server with sufficient frequency to provide an acceptable level of latency in the conversation while only updating a chat session receive frame when a new message is available from the server.

The refresh frame may be provided with a zero footprint configuration to thereby be invisible to a user of the browser. Although the refresh frame may be updated in response to each query issued, there will be no “blinking” or “flashing” visible to the user associated therewith. Moreover, as the visible frames are refreshed only when new or updated data is actually being presented, embodiments of the present invention reduce the amount of blinking associated with refreshing these frames.

Embodiments of the present invention utilize a refresh frame which poses queries for which relatively small amounts of data need be compiled and/or transmitted between the client and server. For example, the query response provided by the server need only be the HTTP header and a few bytes of data, such as to indicate whether update data is present on the server with respect to the frame or frames. The actual update data, e.g., the messages to be displayed in a chat session receive frame, need only be retrieved from a corresponding database, aggregated into a query response, and transmitted to the client when a change in the data is detected. Accordingly communication bandwidth utilized in the communications is minimized.

Moreover, embodiments of the present invention utilize a database configuration and/or other adaptation at the server to facilitate a simplified determination of when there has been a change in the data. For example, when a first user, e.g., customer submits a message to the server the server may put the message in a table of messages along with corresponding user identification information. The server may also make an entry in a small table of unanswered messages, e.g., a table named customers_unanswered. The unanswered message table entry may comprise, for example, user identification information and the time and date of the entry. This entry may remain in the table until a responding user, e.g. an agent, sends a responding message, at which time the one or more entries made by the first user may be deleted from the unanswered messages table.

When the responding user's refresh frame of the present invention is updated, the server-side code may use the unanswered messages table to determine which data frames displayed to the user, e.g., chat session message frames, need to be updated. The responding user may have one user that he is in an active chat session with. That user's questions and answers may be displayed in the responding user's dialogue frame, for example. When the unanswered messages table is queried and the first user's identification information is found, the responding user's dialogue frame should be refreshed. Session variables may be used to insure that an entry only causes one refresh.

As the server-side code builds the refresh frame it may set a flag to indicate that the dialogue frame needs to be refreshed. The updated refresh frame may be sent to the responding user's browser. Code such as JAVA script, running in the dialogue frame in the responding user's browser (e.g., at a rate of twice per second) can detect the flag included in the updated refresh frame and ask the server to update the dialogue frame.

Similar to the process described above, a table of unanswered messages, e.g., a table named agents_unanswered, may be used to determine when the first user's data frame should be updated. Additionally or alternatively, tables, such as the aforementioned customers_unanswered table and/or other tables maintained at the server, can be used to determine when other user data frames need to be updated. For instance, if customers_unanswered contains the identification information with respect to a customer who has not been assigned an agent, the frame that displays the list of such customers may be updated the first time such an entry is encountered by each agent's session.

From the above, it should be appreciated that queries issued by refresh frames of the present invention may utilize significantly less processing power of the server. Accordingly, embodiments of the present invention may be utilized to accommodate additional clients, e.g., larger numbers of individuals involved in a chat session and/or larger numbers of chat sessions, without unacceptably degrading a server's performance. Similarly, embodiments of the present invention may be utilized to reduce latencies experienced in quasi real-time conversations (e.g., conversations held substantially in real time, although latency is experienced in the exchange of messages) through increasing the periodicity of queries by refresh frames without unacceptably degrading a server's performance.

Directing attention to FIG. 1, a client-server environment adapted according to an embodiment of the present invention is shown. The client-server environment of FIG. 1 includes nodes or user terminals 120, 130, and 140 operable to provide client functionality with respect to a networked system. Correspondingly, the client-server environment of FIG. 1 includes server 110 operable to provide server functionality with respect to a networked system. For example, server 110 may provide shared resources, such as databases, application software, communication portals, gateways, etcetera for access by one or more of user terminals 120, 130, and 140. Accordingly, user terminals 120, 130, and 140 may include client application software adapted to cooperate with server 110 and provide desired interaction resulting in the user terminals accessing the resources of the server.

Network 100 is shown providing data communication between user terminals 120, 130, and 140 and server 110. Network 100 may comprise any type of data communication network, such as the Internet, an intranet, a local area network (LAN), a metropolitan area network (MAN), a wide area network (WAN), the public switched telephone network (PSTN), a cable transmission system, a wireless cellular network, an optical fiber network, radio frequency (RF) links, and the like. Where network 100 comprises the Internet, for example, server 110 may operate as a “web server” and user terminals 120, 130, and/or 140 may utilize a “web browser” as a client application.

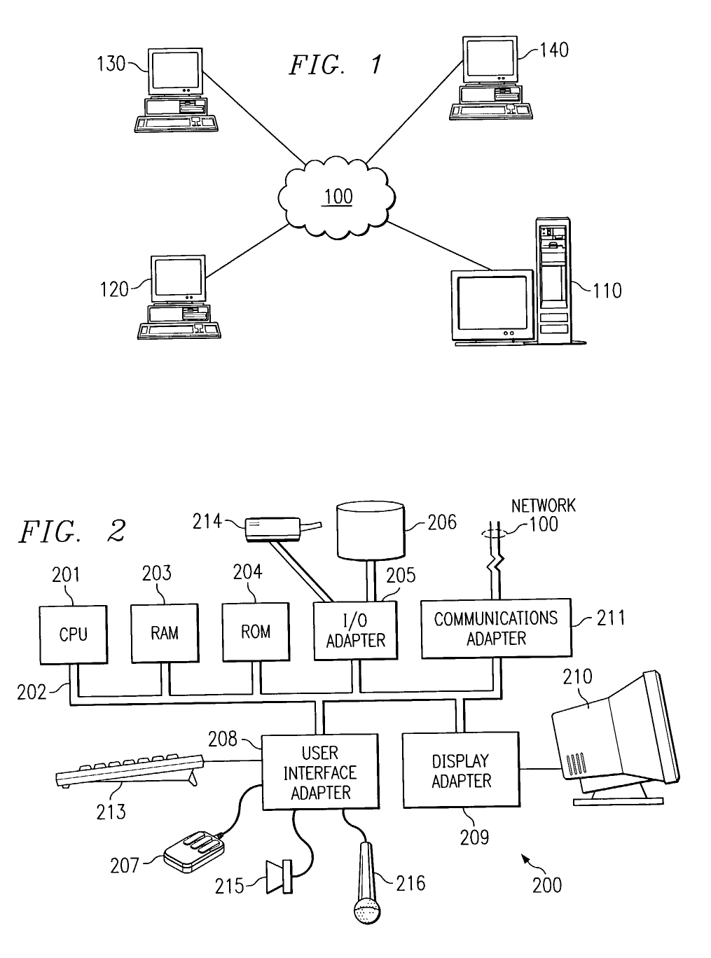

FIG. 2 illustrates computer system 200 which may serve as any of user terminals 120, 130, and 140 and/or server 110. In the illustrated embodiment of computer system 200, central processing unit (CPU) 201 is coupled to system bus 202. The CPU 201 may be any general purpose CPU, such as an HP PA-8500 or Intel PENTIUM processor. However, the present invention is not restricted by the architecture of CPU 201 as long as CPU 201 supports the inventive operations as described herein. Bus 202 is coupled to random access memory (RAM) 203, which may be SRAM, DRAM, SDRAM, or the like. ROM 204 is also coupled to bus 202, which may be PROM, EPROM, EEPROM, or the like. RAM 203 and ROM 204 hold user and system data and programs as is well known in the art.

Bus 202 is also coupled to input/output (I/O) controller card 205, communications adapter card 211, user interface card 208, and display card 209. The I/O adapter card 205 connects to storage devices 206, such as one or more of a hard drive, a CD drive, a floppy disk drive, a tape drive, to the computer system. The I/O adapter 205 is also connected to printer 214, which would allow the system to print paper copies of information such as document, photographs, articles, etc. Note that the printer may be a printer (e.g. dot matrix, laser, etc.), a fax machine, a copier machine, and/or other output device. Communications card 211 is adapted to couple computer system 200 to network 100. User interface card 208 couples user input devices, such as keyboard 213, pointing device 207, and microphone 216, to the computer system 200. User interface card 208 also provides sound output to a user via speaker(s) 215. The display card 209 is driven by CPU 201 to control the display on display device 210.

Although illustrated as a single system, it should be appreciated that any or all of user terminals 120, 130, and 140 and server 110 may, themselves, be comprised of multiple systems. For example, server 110 may provide a web server which is coupled to back-end data systems, as is well known in the art. Similarly, user terminals 120, 130, and/or 140 may be provided in a tiered configuration such that a significant amount of processing, such as the “business logic” for an organization, is removed from the client and disposed in a middle tier between the client and server.

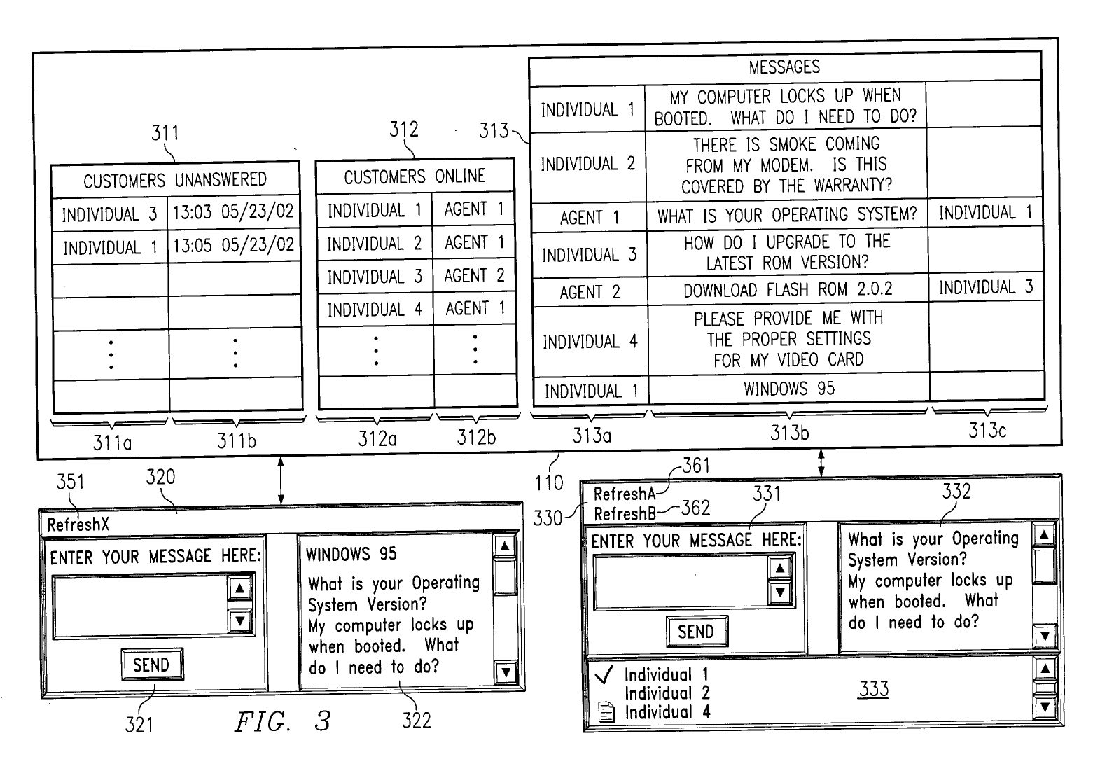

FIG. 3 shows a high level diagram of how a “chat session” conversation might be implemented using an embodiment of the present invention. Specifically, an individual, such as a purchaser of a computer system for which technical support is available, utilizes a user terminal, such as user terminal 120, to initiate a client application, such as an Internet browser. Similarly, another party to the chat session, such as an agent of a computer system supplier, utilizes a user terminal, such as user terminal 130, to initiate a client application, such as an Internet browser.

In the illustrated example, the client application presents a user interface in which at least 2 frames are displayed to the corresponding user. For example, the individual seeking technical support in the example is presented individual's send frame 321, containing a text box to type a message to an agent and a send button, and individual's receive frame 322, displaying the complete dialogue of text typed by both the individual and a computer supplier agent. The agent providing technical support in the example is presented agent's send frame 331, which contains a text box to type a message to send to a customer and a send button, and agent's receive frame 332, displaying the complete dialogue of text typed by the parties to the conversation, here an individual seeking technical support and the computer supplier agent. Although not shown in the illustrated embodiment, often the agent's send frame also contains elements to select a canned message or URL to push to the customer.

It should be appreciated that frames in addition to or in the alternative to those described above may be utilized according to the present invention. For example, the client application utilized by the agent may include conversation select frame 333, displaying the identification of individuals the agent has selected, or which are otherwise assigned, for carrying on conversations with. Moreover, it should be appreciated that embodiments may utilize fewer frames than those of the illustrated embodiment, if desired.

The client applications of the illustrated embodiment each further include a refresh frame of the present invention. Specifically, the client operable with respect to the individual seeking technical support is provided with refresh frame 320 and the client operable with respect to the agent providing technical support is provided with refresh frame 330. These frames may be zero footprint frames, i.e., not displayed to the user. Accordingly, although refresh frames 320 and 330 are visible in FIG. 3, these frames may not be visible upon a user interface.

The refresh frames of the illustrated embodiment are utilized by the client application of each respective node or server in efficiently determining when corresponding data at the client is to be refreshed with data from the server. For example, the illustrated embodiment of refresh frame 320 includes the variable or data field “RefreshX” (reference numeral 351 in FIG. 3) which is a state flag or status indicator associated with corresponding individual's receive frame 322. Specifically, RefreshX of the illustrated embodiment will be set to true if server 110 has determined that the agent has sent a new message which requires individual's receive frame 322 to be refreshed. Thereafter, a refresh operation may be invoked with respect to individual's receive frame 322 to refresh the frame with new data from server 110. Similarly, refresh frame 330 of the illustrated embodiment includes the variables or data fields “RefreshA” and “RefreshB” (reference numerals 361 and 362 in FIG. 3) which are state flags or status indicators associated with corresponding agent's receive frame 332 and conversation select frame 333, respectively. Accordingly, RefreshA of the illustrated embodiment will be set to true if server 110 has determined that the currently selected individual has sent a new message which requires agent's receive frame 332 to be refreshed. RefreshB of the illustrated embodiment will be set to true if server 110 has determined that any currently non-selected individual has sent a new message which requires conversation select frame 333 to be refreshed.

Server 110 in the illustrated embodiment includes a plurality of database tables utilized according to the present invention. The plurality of database tables of the illustrated embodiment are adapted to provide efficiency with respect to server 110 providing query responses associated with the fields of the aforementioned refresh fields, e.g., RefreshA, RefreshB, and RefreshX. However, it should be appreciated that other database configurations are possible according to the present invention.

Server 110 of the illustrated embodiment includes message table 313 for storing messages associated with the chat sessions hosted thereby. Message table 313 may include a plurality of fields, such as identification field 313a, providing identification of the creator of the particular message, chat text field 313b, providing the actual text of the message, and miscellaneous filed 313c, such as may be utilized to provide information associated with the message. For example, in the illustrated embodiment, as an agent may be conversing with more than one individual, miscellaneous field 313c may be utilized to indicate a particular individual agent's messages are directed toward. Of course, additional or alternative fields may be utilized with respect to message table 313, if desired.

Server 110 of the illustrated embodiment further includes customers online table 312 for providing information to agents with respect to individuals for which chat sessions are to be established. Customers online database 312 may include a plurality of fields, such as identification field 312a, providing identification of the individual desiring a chat session, and agent identification field 312b, providing identification of an agent having selected, or otherwise having been assigned, a particular individual for a chat session. Of course, additional or alternative fields may be utilized with respect to customers online table 312, if desired.

Additionally, server 110 of the illustrated embodiment includes customers unanswered table 311 of the present invention. Customers unanswered table 311 may include a plurality of fields, such as identification field 311a, providing identification of the individual having posted a message which is unanswered, and time/date field 311b, providing temporal information with respect to posting of the unanswered message. Of course, additional or alternative fields may be utilized with respect to customers unanswered table 311, if desired.

It should be appreciated that, although an individual may be enabled to type messages into individual's send frame 321, server 110 will not be updated until the client updates the server, such as in response to control manipulation by the individual. After input of a message and manipulation of the client to update server 110, the message may be stored in message table 313 of the illustrated embodiment. Although the individual may have composed a message and caused the individual's browser to update message table 313 to include the message, and perhaps individual's receive frame 322 to include the message sent, agent's receive frame 332 will not yet display this message. This is because the agent's browser needs to query the message data from server 110. Accordingly, the second sent message appearing in individual's receive frame 322, “WINDOWS 95” associated with “INDIVIDUAL1”, although appearing in message table 313, does not appear in agent's receive frame 332.

In providing refreshing of data within ones of the displayed frames according to the present invention, the aforementioned refresh frames are utilized to query server 110. Accordingly, various disadvantages associated with repeatedly refreshing frames in accordance with previously known techniques, particularly those containing a relatively large amount of data or those visible to the user, are avoided. For example, the use of refresh frames of the illustrated embodiment results in reduced “blinking” or “flicker” of the visible frames. Additionally, the use of refresh frames of the illustrated embodiment results in decreased processing demand being placed upon server 110 in responding to refresh queries.

Tables 311 and 312 of the illustrated embodiment are utilized with respect to refresh queries associated with refresh frames 320 and/or 330 according to the present invention. For example, when customers unanswered database 311 indicates that an unanswered message is present associated with a currently selected individual, RefreshA may be set to true by server 110 in a response to a refresh query associated with refresh frame 330. Similarly, when database 311 indicates that an unanswered message is present associated with a currently non-selected individual, RefreshB may be set to true by server 110 in response to a refresh query associated with refresh frame 330.

Customers unanswered table 311 may be utilized to indicate when an agent has posted a message which has not been responded to by a corresponding individual. However, as there is a one to many relationship for agents with respect to individuals in the illustrated embodiment, it may be useful to include information indicating to whom the agent's message is directed in the database or otherwise associated with the message. According to an embodiment of the present invention, an agents unanswered table (not shown) is utilized to facilitate refreshing individual's client data. Such a database may be configured substantially as customer unanswered table 311, with the identification information identifying an intended recipient rather than the creator of the message.

The true condition of either of the aforementioned refresh frame data fields may be recognized by the client application and, thereafter, a refresh query may be invoked with respect to the corresponding visible frame, agent's receive frame 332 and conversation select frame 333, to obtain the updated data from server 110, such as from table 313, for display in the appropriate frame.

Customers online table 312 of the illustrated embodiment may also be utilized in providing query responses. For example, the aforementioned refresh frame queries may utilize customers online table 312 in order to determine which entries of customers unanswered table 311 are pertinent to the condition of the RefreshA and RefreshB fields of the refresh frame of any particular agent.

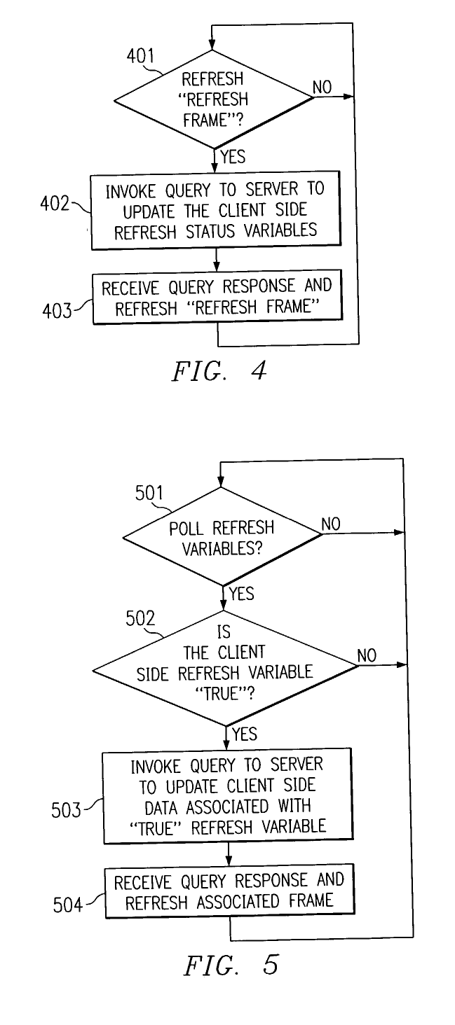

Directing attention to FIGS. 4 and 5, flow diagrams of operation of a client with respect to acquiring updated data from a server using the refresh frames of the illustrated embodiment are shown. FIG. 4 shows an embodiment of a flow diagram for a client, e.g., the individual's or agent's client of FIG. 3, refreshing one or more refresh frames to update the refresh field(s) therein (i.e., logic of a refresh frame). FIG. 5 shows an embodiment of a flow diagram for a client, e.g., the individual's or agent's client of FIG. 3, refreshing one or more visible frames to update the data displayed therein (i.e., logic of a data frame). The steps of the flow diagrams of FIGS. 4 and 5 may operate simultaneously, serially, or otherwise as desired.

According to the illustrated embodiment, server 110 is queried periodically to determine if new information which should be displayed by the querying client is present upon the server. However, to increase the speed at which query responses may be compiled, to decrease the processing power required by the server in compiling a query response, blind queries, i.e., queries where it is yet undetermined if there is update information available, are made with respect to the refresh frames of the present invention. Accordingly, at step 401 a determination is made as to whether it is time to invoke a refresh frame refresh query. If a predetermined amount of time since a last refresh frame refresh has elapsed, processing continues to step 402. However, if the predetermined amount of time since a last refresh frame refresh has not elapsed, processing returns to step 401.

According to embodiments of the present invention, the periodicity of refresh frame refresh queries is in a range of from 2 seconds to 10 seconds, e.g., approximately 3 seconds according to one embodiment. This amount of time has been determined to provide a substantially unnoticeable amount of latency with respect to a quasi real-time conversation and, using the refresh fields of the present invention, result in a sustainable impact upon the processing capacity of a typical web server. However, it should be appreciated that other refresh frame refresh periods may be utilized according to the present invention. For example, the refresh frame refresh period may be adjusted based upon such considerations as an amount of latency acceptable with respect to the conversations conducted, an amount of processing power utilized by the server in responding to refresh frame queries, an amount of communication bandwidth available, a number of users of the system, and the like.

At step 402 a query is invoked from the client to the server to update the refresh status variable or variables of the refresh frame. For example, in the case of the illustrated agent's client, refresh variables RefreshA and RefreshB may be the subject of the query. Likewise, in the case of the illustrated individual's client, refresh variable RefreshX may be the subject of the query.

Server 110 of the illustrated embodiment receives the refresh frame query and determines if any refresh variables should be set to “true”. For example, the server may reference information within or associated with the query to determine the particular client making the query. Server 110 may then reference customers online table 312 to identify another party to the conversation. Server 110 may utilize the identity information of customers online table 312 to determine if a party to the conversation has posted a message which is unanswered by referencing customers unanswered table 311.

Customers unanswered table 311 may be updated by server 110 every time a client posts a message to message table 313. For example, an individual may have posted the response “WINDOWS 95” shown in individual's send window 321 to table 313, whereupon server 110 may make a corresponding entry, here “INDIVIDUAL1”, in customers unanswered table 311. The corresponding agent's received frame 332 has not yet been updated to include this posted message and, accordingly, server 110 may compile a query response in which RefreshA is set to “true”. It should be appreciated that, according to the illustrated embodiment, the database or databases queried with respect to the refresh frame query are relatively small tables, having very few entries and/or relatively information to parse through. Moreover, very little data communication is required in invoking the query, as well as in receiving the query response, as a small number of state variables are updated and the data associated with these variables is small.

An entry in customers unanswered table 311 may be removed, for example, upon the corresponding party to the conversation posting a message directed to the indicated unanswered party. Of course, posting of such a message may likewise cause server 110 to update customers unanswered table 311 to include an entry for the then posting party for use in refreshing the other party's receive frame according to the present invention, if desired. Server 110 may maintain session variables so that an unanswered message only causes a refresh the first time it is detected. Accordingly, refreshing of the corresponding visible fields may be avoided upon subsequent detection of a particular party's message in customers unanswered table 311, although the posted message remains unresponded to by the other party.

At step 403 a query response is received by the client from the server which updates the refresh status variable or variables of the refresh frame. It should be appreciated that, because the illustrated embodiment utilizes a zero footprint refresh frame, there is no visual impact upon the user with respect to the updating of the refresh frame.

According to the illustrated embodiment, the client refreshes particular ones of the displayed frames when a corresponding refresh variable indicates that update information is present upon server 110, thereby avoiding blind refreshing of these displayed frames. Accordingly, these client side refresh variables are polled periodically to determine if new information which should be displayed is present upon the server. At step 501 of FIG. 5 a determination is made as to whether it is time to poll the refresh variables of the refresh frame. If a predetermined amount of time since a last polling of these variables has elapsed, processing continues to step 502. However, if the predetermined amount of time since a polling of these variables has not elapsed, processing returns to step 501.

According to embodiments of the present invention, the periodicity of polling refresh frame refresh variables is in a range of from 0.1 second to 1.0 second, e.g., approximately 0.5 second according to one embodiment. This amount of time has been determined to provide a substantially unnoticeable amount of latency with respect to a quasi real-time conversation and results in a sustainable impact upon the processing capacity of a typical client application. However, it should be appreciated that other refresh variable polling periods may be utilized according to the present invention. Typically, the period of the refresh variable polling period will be selected to be substantially less than the refresh frame refresh period in order to minimize latency in the conversation experienced by the user.

At step 502 it is determined whether the refresh variables indicate updated data with respect to a displayed frame is present upon the server, e.g., a refresh variable is “true”. If a refresh variable, e.g., refresh variables RefreshA and RefreshB in the case of the illustrated agent's client and refresh variable RefreshX in the case of the illustrated individual's client, indicates updated data is present upon the server processing continues to step 503. However, if no refresh variable indicates updated data is present upon the server processing continues to step 501, thereby avoiding unnecessarily refreshing the displayed frames.

At step 503 a query is invoked from the client to the server to update the particular frame or frames associated with the refresh variable indicating update data is present. For example, in the case of the illustrated agent's client, refresh variable RefreshA having a “true” state will result in a refresh query with respect to agent's receive frame 332 and refresh variable RefreshB having a “true” state will result in a refresh query with respect to conversation select frame 333. Likewise, in the case of the illustrated individual's client, refresh variable RefreshX having a “true” state will result in a refresh query with respect to individuals receive frame 322.

Server 110 of the illustrated embodiment receives the frame query and compiles a query response. For example, if the query is with respect to agent's receive frame 332, server 110 may reference customers online table 312 to identify a particular individual currently selected by the corresponding agent and parse message table 313 for all messages from that individual. If the query is with respect to conversation select frame 333, server 110 may reference customers online table 312 to identify particular individuals not currently selected by the corresponding agent and parsing customers unanswered 311 for the identification of any such individual having an unanswered message posted. These messages, including the updated message identified in customers unanswered table 311, may be provided in a query response for transmission to the querying client.

At step 504 a query response is received by the client from the server which updates the appropriate frame with the updated information. For example, agent's receive frame 332 may be refreshed to include all the messages from the selected individual, including an updated message. Similarly, conversation select frame 333 may be refreshed to include a message icon next to the identity of each currently non-selected individual having an unanswered message posted upon server 110. It should be appreciated that, because the illustrated embodiment utilizes a refresh frame for determining if update data is present, blinking or flashing associated with the displayed frames is experienced only when data is updated.

Although the flow diagrams of FIGS. 4 and 5 illustrate steps providing periodic automatic updating or refreshing of data at the client, it should be appreciated that such updating or refreshing of data may additionally or alternatively occur at other times. For example, a client may query message data from the server in response to manual control by a user. Similarly, such queries may be invoked upon the occurrence of another function. For example, a user's manipulation of the client to post a message to the server may also operate to query the server with respect to new messages posted for that user, if desired.

Although the illustrated embodiment shows the use of refresh variables of a refresh frame for each frame to be updated with information from a server, it should be appreciated that there is no such requirement according to the present invention. For example, it may be determined that displayed frames presenting relatively little data or for which a query response requires very little processing by a server may be more expediently served using blind refreshes. Accordingly, one or more frames may be refreshed using conventional or other techniques while one or more other frames are refreshed using techniques of the present invention. However, it should be appreciated that use of the refresh techniques of the present invention may be preferred, even where a series of conventional blind refreshes do not significantly impact a server, in order to provide advantages such as the aforementioned reduction in visible blinking or flashing associated with a frame refresh.

When implemented in software, the elements of the present invention are essentially the code segments to perform the necessary tasks. For example, programs or code segments for refreshing refresh frames and for referencing refresh variables for refreshing displayed frames may be provided in the form of JAVA scripts operable upon a browser client according of an embodiment of the present invention. Of course, other programming languages, such as C, C+, XML, etcetera, may be utilized in providing embodiments of the present invention, if desired. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

Although embodiments of the present invention have been described herein with reference to a client-server environment, the concepts of the present invention are not limited to application with respect to a client-server environment. Accordingly, it should be appreciated that the present invention may be implemented with respect to a variety of shared resource environments, whether meeting the definition of a client-server environment or not.

Moreover, although embodiments of the present invention have been described herein with reference to conducting quasi real-time chat sessions, the concepts of the present invention are not limited to application with respect to chat sessions or even quasi real-time events. Accordingly, it should be appreciated that the present invention may be implemented with respect to any data requiring refreshing or updating.

What is claimed is:

1. A method for updating data at a node in a network system, said method comprising:
providing a refresh status indicator at said node, wherein said refresh status indicator indicates a changed status with respect to data stored at said node and corresponding data stored at a server of said network system;
periodically querying said server with respect to said refresh status indicator;
updating said refresh status indicator to reflect a changed status with respect to said data stored at said node and said corresponding data stored at said server;
periodically polling said status indicator to determine a status indicated thereby; and
if said status indicated by said status indicator during said polling reflects a changed status with respect to said data stored at said node and said corresponding data stored at said server, querying said server with respect to said corresponding data stored at said server.

2. The method of claim 1, wherein said refresh status indicator is hidden from view of a user of said node.

3. The method of claim 2, wherein said refresh status indicator is maintained within a zero footprint frame of a client application operable upon said node.

4. The method of claim 2, wherein said data stored at said node is visible to a user of said node.

5. The method of claim 1, wherein a periodicity of said periodically querying said server is selected to provide at least one of an acceptable latency with respect to updating data at said node and an acceptable impact upon processing by said server.

6. The method of claim 5, wherein a periodicity of said periodically polling status indicator is selected to provide at least one of an acceptable latency with respect to updating data at said node and an acceptable impact upon processing by said node.

7. The method of claim 6, wherein said periodicity of said periodically polling said status indicator is less than said periodicity of said periodically querying said server.

8. The method of claim 7, wherein said periodicity of said periodically querying said server is in a range of from 2 seconds to 10 seconds and said periodicity of said periodically polling said status indicator is in a range of from 0.1 second to 1.0 second.

9. The method of claim 1, wherein said node is operable under control of a browser client application displaying at least a part of said data stored at said node in a visible frame.

10. A method for updating data displayed by a browser at a user terminal, said method comprising:
configuring said browser to comprise at least one field displaying at least a portion of said data and at least one hidden field for maintaining a refresh status indicator;
periodically refreshing said hidden field;
periodically polling said refresh status indicator to determine a status indicated thereby; and
if said status indicated by said status indicator during said polling reflects a data changed status, refreshing said at least one field displaying at least a portion of said data.

11. The method of claim 10, wherein said browser comprises an Internet browser and said refreshing said hidden field and said refreshing said at least one field displaying at least a portion of said data comprises:
querying an Internet server.

12. The method of claim 11, wherein said data is associated with a quasi real-time conversation conducted over the Internet via said Internet server.

13. The method of claim 12, wherein said periodically refreshing said hidden field is performed at intervals determined to avoid unacceptable latency with respect to said quasi real-time conversation.

14. The method of claim 13, wherein said periodically polling said refresh status indicator is performed at more intervals than said intervals with respect to said periodically refreshing said hidden field.

15. The method of claim 10, wherein said at least one hidden field maintains a plurality of refresh status indicators, wherein refresh status indicators of said plurality are associated with different portions of said data.

16. A system for updating data in a client-server environment, said system comprising:
a browser having at least one visible frame and at least one invisible frame, wherein said visible frame displays at least a portion of said data to a user, and wherein said invisible frame maintains a status indicator associated with said data, wherein said browser is operable to reference said invisible frame in forming a refresh query associated with said visible frame; and
a server having a database storing said data and a database storing information with respect to said data having been changed, wherein said server is operable to reference said database storing information with respect to said data having been changed in response to a refresh query by said browser associated with said invisible frame, and wherein said server is further operable to reference said database storing said data in response to said refresh query by said browser associated with said visible frame.

17. The system of claim 16, wherein said client-server environment comprises the Internet, said browser comprises an Internet browser, and said server comprises a web server.

18. The system of claim 16, wherein said database storing said data comprises a message database storing text of a conversation between a user of said browser and another user of said client-server environment.

19. The system of claim 18, wherein said database storing information with respect to said data having been changed stores an identity of a client posting information to said database storing said data.

20. The system of claim 16, wherein said browser has a plurality of visible frames and said invisible frame maintains a plurality of status indicators, wherein a first status indicator of said plurality of status indicators is associated with a first frame of said plurality of frames and a second status indicator of said plurality of status indicators is associated with a second frame of said plurality of frames.
